(19) United States
(12) Patent Application Publication
(10) Pub. No.: US 2011/0168019 A1
(43) Pub. Date: Jul. 14, 2011

(54) Removal of Acid Gases From A Gas Stream

(76) Inventors: Paul Scott Northrop, Spring, TX (US); Edward J. Grave, Spring, TX (US); John T. Cullinane, Missouri City, TX (US)

(21) Appl. No.: 13/119,356

(22) PCT Filed: Aug. 27, 2009
(86) PCT No.: PCT/US09/55197

§ 371 Date: Mar. 16, 2011

Related U.S. Application Data
(60) Provisional application No. 61/105,343, filed on Oct. 14, 2008.

(51) Int. Cl. B01D 53/14

(52) U.S. Cl. 95/186; 96/234; 96/52; 96/242

(57) ABSTRACT

A gas processing facility for the separation of fluids is provided. The facility includes co-current contactors placed in series. Each co-current contactor receives a gas stream that includes a non-absorbing gas such as a hydrocarbon gas or nitrogen. The gas stream also includes an acid gas or other contaminant. Each co-current contactor also receives a liquid solvent stream. The co-current contactors then each release a sweetened gas stream and a gas-treating solution. In one processing direction, the contactors are arranged to deliver progressively sweetened gas streams. In the opposite processing direction, the contactors are arranged to deliver progressively richer gas-treating solutions. In one aspect, the facility includes at least a first co-current contactor, a second co-current contactor and a final co-current contactor. However, any number of at least two co-current separators may be employed. Methods and processes for separating a gas stream are also provided.

### CROSS REFERENCE TO RELATED APPLICATIONS

This application claims the benefit of U.S. Provisional Application No. 61/105,343 filed Oct. 14, 2008.

### BACKGROUND OF THE INVENTION

1. Field of the Invention

The present invention relates to the field of fluid separation. More specifically, the present invention relates to the separation of acid gases from a hydrocarbon fluid stream or from a flue gas stream.

2. Discussion of Technology

The production of hydrocarbons from a reservoir oftentimes carries with it the incidental production of non-hydrocarbon gases. Such gases include contaminants such as hydrogen sulfide (H₂S) and carbon dioxide (CO₂). When H₂S and CO₂ are produced as part of a hydrocarbon gas stream (such as methane or ethane), the raw gas stream is sometimes referred to as “sour gas.” The H₂S and CO₂ are often referred to together as “acid gases.”

Acid gases may also be associated with synthesis gas streams, or with refinery gas streams. Acid gases may also be generated by the combustion of carbonaceous materials such as coal, natural gas or other carbonaceous fuels. In any instance, raw gas streams may contain other “acidic” impurities. These include mercaptans and other trace sulfur compounds. Such impurities should be removed prior to industrial or residential use.

While H₂S, mercaptans and trace sulfur compounds have long been captured through separation processes, CO₂ has oftentimes simply been vented to the atmosphere. However, the practice of venting CO₂ is coming under greater scrutiny, particularly in countries that have ratified the Kyoto protocol which requires the reduction of CO₂ emissions. Therefore, processes for removing CO₂ are of greater interest to industries that operate gas processing facilities, particularly within the oil and gas production industry.

Processes have been devised to remove acid gas from a raw natural gas stream. In some instances cryogenic gas processing is used. In other instances, the hydrocarbon fluid stream is treated with a solvent. Solvents may include chemical solvents such as amines. Examples of amines used in sour gas treatment include monoethanol amine (MEA), diethanol amine (DEA), and methyl diethanol amine (MDEA).

Physical solvents are sometimes used in lieu of amine solvents. Examples include Selexol® and Rectisol™. In some instances hybrid solvents, meaning mixtures of physical and chemical solvents, have been used. An example is Sulfinol®. However, the use of amine-based acid gas removal solvents is most common.

Amine-based solvents rely on a chemical reaction with the acid gases. The reaction process is sometimes referred to as “gas sweetening.” Such chemical reactions are generally more effective than the physical-based solvents, particularly at feed gas pressures below about 300 psia (2.07 MPa). There are instances where special chemical solvents such as FLEXSORB™ are used, particularly for selectively removing H₂S from CO₂-containing gas streams.

As a result of the gas sweetening process, a treated or “sweet” gas stream is created. The sweet gas stream has been substantially depleted of H₂S and/or CO₂ components. The sweet gas can be further processed for liquids recovery, that is, by condensing out heavier hydrocarbon gases. The sweet gas may alternatively be sold into a pipeline or used for liquefied natural gas (LNG) feed if the CO₂ concentration is less than, for example, about 50 ppm. In addition, the sweetened gas stream may be used as feedstock for a gas-to-liquids process, and then ultimately used to make waxes, butanes, lubricants, glycols and other petroleum-based products. The extracted CO₂ may be sold or otherwise used for enhanced oil recovery operations.

Traditionally, the removal of acid gases using chemical solvents involves counter-currently contacting the raw natural gas stream with the solvent. The raw gas stream is introduced into the bottom section of a contacting tower. At the same time, the solvent solution is directed into a top section of the tower. The tower has trays, packings or other “internals.” As the liquid solvent cascades through the internals, it absorbs the undesirable acid gas components, carrying them away through the bottom of the contacting tower as part of a “rich” solvent solution. At the same time, gaseous fluid that is largely depleted of H₂S and/or CO₂ exits at the top of the tower.

It is common to use a variety of absorbent liquids to absorb acid gases (H₂S and/or CO₂) from gas or hydrocarbon liquid streams. Upon absorption, the absorbent liquid is said to be “rich.” Following absorption, a process of regeneration (also called “desorption”) may be employed to separate acid gases from the active solvent of the absorbent liquid. This produces a “lean” solvent that is then typically recycled for further absorption.

An example of a gas sweetening process is demonstrated in FIG. 1. FIG. 1 is a schematic view of a known gas processing facility for the removal of acid gas from a raw gas stream. An illustrative tower for counter-currently contacting CO₂ with lean solvent is seen at 114. The vigorous contacting between the raw gas stream and the liquid solvent within the tower 114 permits CO₂ (or other acid gas) to be absorbed by the solvent. The facility of FIG. 1 is discussed in greater detail below.

Known counter-current contactor towers (such as tower 114) used for H₂S and CO₂ scrubbing tend to be very large and heavy. This creates particular difficulty in offshore oil and gas production applications. Accordingly, a need exists for an improved gas processing facility useful for the removal of acid gases from hydrocarbon gas streams incident to oil and gas recovery that employs primarily smaller, co-current contacting devices.

It is noted that International Patent Publication WO 03/072226, entitled “Acid Gas Removal,” teaches the use of a “contactor unit 50” that includes two “mixers.” One or both of the mixers may be a co-current device for the removal of acid gases. The mixers provide pre-treating of a sour gas stream (stream 5) before the gas (pre-treated gas stream 5a) is delivered to a conventional counter-current column (contactor 1). The two mixers in the contactor unit 50 receive only a semi-lean amine for the pre-treating process. This semi-lean amine comes from four separate “used” amine streams 29, 30, 36 and 53 within the facility. The pre-treated gas stream 5a leaving the contactor unit 50 remains only partially sweetened. Further acid gas removal takes place in the traditional counter-current column 1 using a regenerated amine from regeneration unit 11.

Recently, an interest has developed in capturing and sequestering CO₂ from the flue gas of power generation plants and other types of industrial plants. It is estimated by some that approximately 40% of all CO₂ emissions in the United States are generated by power plants. It is desirable to capture the CO₂ and either store it in a subsurface reservoir or perhaps use it as a miscible enhanced oil recovery (EOR) agent to recover additional oil. Accordingly, a need further exists for an improved gas processing facility useful for the removal of CO₂ from the flue gas of power generation plants.

### SUMMARY OF THE INVENTION

A gas processing facility is provided for the separation of components of a fluid stream. The fluid stream contains at least one non-absorbing gas and an acid gas. The acid gas may be carbon dioxide, hydrogen sulfide, or combinations thereof. The fluid stream may be, for example, a gas stream from a hydrocarbon recovery operation, a flue gas stream from an industrial plant, or a gas stream created within a gas processing facility. Alternatively, the fluid stream may be a sour gas stream from within an oil refinery, such as a gas stream from a catalytic hydrodesulfurization process, a tail gas stream from a Claus sulfur recovery process, an acid gas stream from a solvent regeneration process requiring H₂S enrichment, or a synthesis-gas stream.

The facility includes a plurality of co-current contactors placed in series. Each co-current contactor receives a gas stream that includes a non-absorbing gas and an acid gas. The non-absorbing gas may be nitrogen or a hydrocarbon gas, for example. Each co-current contactor also receives a liquid solvent stream. The co-current contactors then each release a sweetened gas stream and a separate gas-treating solution. In one processing direction, the contactors are arranged to deliver progressively sweetened gas streams. In the opposite processing direction, the contactors are arranged to deliver progressively richer gas-treating solutions solutions.

The facility includes a first co-current contactor and at least a final co-currentcontactor. Any number of intermediate co-current contactors, i.e., a second contactor, a third contactor, etc. may be employed to further reduce acid gas content from the fluid stream. The number of contactors employed in series is dependent on the acid gas concentration in the original gas stream and the degree of desired acid gas removal, or “sweetening,” desired.

The first co-current contactor is configured to receive (i) an initial gas stream containing the non-absorbing gas and the acid gas and (ii) a second liquid solvent. The second liquid solvent is generated by a subsequent contactor in the series, which may be either a second contactor or, if only two contactors are used, a final contactor. The first contactor is also configured to release (iii) a first partially-sweetened gas stream and (iv) a first partially-loaded gas-treating solution.

The facility optionally includes a second co-current contactor in series with the first co-current contactor. The second contactor is configured to receive (i) the first partially-sweetened gas stream and (ii) a third liquid solvent. The third liquid solvent is generated by a subsequent contactor in the series, which may be either a fourth contactor or, if only three contactors are used, a final contactor. The second contactor is also configured to release (iii) a second partially-sweetened gas stream and (iv) a second partially-loaded gas-treating solution. In this instance, the second partially-loaded gas-treating solution is the second liquid solvent.

The final contactor is in series with the first contactor and any other contactors optionally employed intermediate to the first contactor and the final contactor. An example would be the second contactor. The final co-current contactor is configured to receive (i) a subsequent sweetened gas stream and (ii) a regenerated liquid solvent. The subsequent contactor is also configured to release (iii) a final sweetened gas stream and (iv) a final lightly-loaded gas-treating solution. Where only the second contactor is used intermediate to the first and final contactors, the subsequent sweetened gas stream received by the final contactor is the second partially-sweetened gas stream released by the second contactor. Of course, where additional contactors are used, the subsequent sweetened gas stream is the sweetened gas stream from the last contactor in series prior to the final contactor. The present inventions are not limited by the number of co-current contactors used to produce the final sweetened gas stream. However, it is preferred that at least three be used.

In one embodiment, three co-current contactors are utilized in series in addition to the final contactor. In this arrangement, the final sweetened gas stream received by the final co-current contactor comprises a third partially-sweetened gas stream released from a third co-current contactor. A fourth liquid solvent received by the third contactor comprises the final lightly-loaded gas treating solution released by the final contactor.

The facility preferably further includes a liquid solvent regenerator configured to receive at least the first partially-loaded gas-treating solution, and to produce the regenerated liquid solvent stream. The regenerated liquid solvent received by the final co-current contactor is comprised at least in part of the regenerated liquid solvent stream whereby an acid gas has been substantially removed from at least the first partially-loaded gas-treating solution.

In one aspect, the acid gas comprises primarily carbon dioxide. In this instance, the second liquid solvent and the regenerated liquid solvent are selected to remove carbon dioxide from the gas stream. In another aspect, the acid gas comprises primarily hydrogen sulfide. In this instance, the second liquid solvent and the regenerated liquid solvent are selected to remove hydrogen sulfide from the gas stream. It is understood that H₂S and CO₂ may be absorbed through separate processes that are performed sequentially.

A method of separating an initial gas stream in a gas processing facility is also provided. The gas stream includes a non-absorbing gas and an acid gas. The initial gas stream is preferably a gas stream from a hydrocarbon recovery operation or a flue gas stream from an industrial plant. In the case of a hydrocarbon recovery operation, the non-absorbing gas is typically a hydrocarbon gas; in the case of a flue gas from an industrial plant, the non-absorbing gas is typically nitrogen.

In one embodiment, the method includes the step of providing at least a first co-current contactor, a second co-current contactor and a final co-current contactor. Each of these co-current contactors is configured to receive a gas stream and a liquid solvent. Further, each of these contactors is configured to release a sweetened gas stream and a separate partially-loaded gas-treating solution.

The method also includes arranging the first co-current contactor, the second co-current contactor and the final co-current contactor to deliver progressively sweetened gas streams in series, and further arranging the final co-current contactor, the second co-current contactor and the first co-current contactor to deliver progressively richer amine solutions in series. Thus, the progressively sweetened gas streams are released in a first processing direction while the progressively richer gas treating solutions are released in a second opposite processing direction. In addition, the method includes delivering a regenerated liquid solvent to the final co-current contactor, and operating the gas processing facility in order to remove acid gas from the initial gas stream and to deliver a final sweetened gas stream.

In one aspect,

the first co-current contactor receives (i) the initial gas stream and (ii) a second liquid solvent, and releases (iii) a first partially-sweetened gas stream and (iv) a first partially-loaded gas-treating solution;

the second co-current contactor receives (i) the first partially-sweetened gas stream from the first co-current contactor and (ii) a subsequent intermediate liquid solvent, and releases (iii) a second partially-sweetened gas stream and (iv) a second partially-loaded gas-treating solution, and

the final co-current contactor receives (i) a penultimate partially-sweetened gas stream and (ii) a regenerated liquid solvent, and releases (iii) the final sweetened gas stream and (iv) a final lightly-loaded gas-treating solution.

Where only these three contactors are used, the first intermediate liquid solvent is the final partially-loaded gas-treating solution from the first contactor, and the subsequent sweetened gas stream is the second partially-sweetened gas stream.

In another aspect, a process is provided for removing a gaseous component from a gas stream, the method comprising:

(a) passing the gas stream through a first contactor and subsequently passing the gas stream through a second contactor;

(b) commingling and contacting the gas stream in the second contactor with a third absorbent liquid, wherein the third absorbent liquid and the gas stream flow co-currently in the second contactor, thereby producing a partially-loaded second absorbent liquid having a second concentration of the gaseous component and producing a gas stream depleted of the gaseous component;

(c) recovering the partially-loaded second absorbent liquid from the second contactor;

(d) passing a second absorbent liquid to the first contactor and commingling and contacting the gas stream in the first contactor with the second absorbent liquid,

wherein:
the second absorbent liquid and the gas stream flow co-currently through the first contactor, and
the first absorbent liquid comprises at least a portion of the partially-loaded second absorbent liquid, thereby producing a first absorbent liquid having a first concentration of gaseous component, the first concentration of the gaseous component in the first absorbent liquid being higher than the second concentration of the gaseous component in the second absorbent liquid; and

(e) recovering the first absorbent liquid from the first contactor.

A process for removing a gaseous component from a gas stream is also provided. In one aspect, the method includes the steps of:

(a) sequentially flowing the gas stream through a series of two or more contactors in a downstream direction; and

(b) passing an absorbent liquid through each of the two or more contactors co-currently with the flow of the gas stream, and recovering from each of the two or more contactors an absorbent liquid effluent stream comprising the gaseous component,

wherein:
the gas stream is progressively depleted of the gaseous component as the gas stream passes through each of the two or more contactors in the downstream direction,
the recovered absorbent liquid from each of the two or more contactors has a progressively higher concentration of the gaseous component in the upstream direction; and
at least a portion of the absorbent liquid recovered from one of the two or more contactors is used as the absorbent liquid for at least one contactor upstream of the flow of the gas stream.

Sequentially flowing the gas stream may comprise, for example, passing the gas stream through a first contactor, then through at least one additional contactor, and then through a final contactor.

Passing an absorbent liquid may comprise:

passing absorbent liquid recovered from the final contactor to a penultimate contactor,

passing absorbent liquid recovered from the penultimate contactor to an antepenultimate contactor, and

continuing recovery of the absorbent liquid from sequential contactors in the upstream direction, except that the absorbent liquid recovered from the first contactor is passed to a regeneration system, thereby producing a lean absorbent liquid, and

wherein the process further comprises recycling the lean absorbent liquid as the absorbent liquid for passing to the final contactor.

### BRIEF DESCRIPTION OF THE DRAWINGS

So that the manner in which the present invention can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a schematic view of a known gas processing facility for the removal of acid gas from a raw gas stream. This process uses a counter-currently contacting tower.

FIG. 2A is a schematic view of a gas processing facility for the removal of acid gas from a gas stream in accordance with the present invention, in one embodiment. The gas stream may be a gas stream incident to a hydrocarbon production operation, some other gas stream containing a hydrocarbon gas, or a flue gas stream from an industrial plant.

FIG. 2B is a schematic view of a gas processing facility for the removal of acid gas from a gas stream, in an alternate embodiment. The gas stream may again be a gas stream incident to a hydrocarbon production operation, a flue gas stream from an industrial plant, or other gas stream.

FIG. 3A is a schematic view of a portion of the gas processing facility of FIG. 2A, in one embodiment. Here, three co-current separating devices or “contactors” are placed within a shell.

FIG. 3B is schematic of a portion of the gas processing facility of FIG. 2A, in another embodiment. Here, dedicated coolers are used for cooling selected solvent solutions to a cooler temperature.

FIG. 4 is a schematic view of a portion of the gas processing facility of FIG. 2, in another embodiment. Here, a flash drum and pressure boosting pump are placed along the third rich solvent solution stream.

FIG. 5 is a schematic view of a gas regeneration facility. The facility uses a series of co-current contactors for the removal of acid gas from a rich solvent solution.

### DETAILED DESCRIPTION OF CERTAIN EMBODIMENTS

### Definitions

As used herein, the term “co-current contacting device” or “co-current contactor” means a vessel that receives (i) a stream of gas and (ii) a separate stream of solvent in such a manner that the gas stream and the solvent stream contact one another while flowing in generally the same directions within the contacting device. Non-limiting examples include an eductor and a coalescer, or a static mixer plus deliquidizer.

“Non-absorbing gas” means a gas that is not significantly absorbed by a solvent during a gas sweetening process.

As used herein, the term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C₁) as a significant component. The natural gas stream may also contain ethane (C₂), higher molecular weight hydrocarbons, and one or more acid gases. The natural gas may also contain minor amounts of contaminants such as water, nitrogen, iron sulfide, wax, and crude oil.

As used herein, an “acid gas” means any gas that dissolves in water producing an acidic solution. Nonlimiting examples of acid gases include hydrogen sulfide (H₂S), carbon dioxide (CO₂), sulfur dioxide (SO₂), carbon disulfide (CS₂), carbonyl sulfide (COS), mercaptans, or mixtures thereof.

“Flue gas” means any gas stream generated as a by-product of hydrocarbon combustion.

The term “industrial plant” refers to any plant that generates a gas stream containing at least one hydrocarbon or an acid gas. One nonlimiting example is a coal-powered electrical generation plant. Another example is a cement plant that emits CO₂ at low pressures.

The term “liquid solvent” means a fluid in substantially liquid phase that preferentially absorbs acid gases, thereby removing or “scrubbing” at least a portion of the acid gas components from a gas stream. The gas stream may be a hydrocarbon gas stream or other gas stream, such as a gas stream having nitrogen.

“Sweetened gas stream” refers to a fluid stream in a substantially gaseous phase that has had at least a portion of acid gas components removed.

As used herein, the term “hydrocarbon” refers to an organic compound that includes primarily, if not exclusively, the elements hydrogen and carbon. Hydrocarbons generally fall into two classes: aliphatic, or straight chain hydrocarbons, and cyclic, or closed ring, hydrocarbons including cyclic terpenes. Examples of hydrocarbon-containing materials include any form of natural gas, oil, coal, and bitumen that can be used as a fuel or upgraded into a fuel.

As used herein, the terms “lean” and “rich,” with respect to the absorbent liquid removal of a selected gas component from a gas stream, are relative, merely implying, respectively, a lesser or greater degree of content of the selected gas component The respective terms “lean” and “rich” do not necessarily indicate or require, respectively, either that an absorbent liquid is totally devoid of the selected gaseous component, or that it is incapable of absorbing more of the selected gas component. In fact, it is preferred, as will be evident hereinafter, that the so called “rich” absorbent liquid produced in a first contactor in a series of two or more contactors retains significant or substantial residual absorptive capacity. Conversely, a “lean” absorbent liquid will be understood to be capable of substantial absorption, but may retain a minor concentration of the gas component being removed.

As used herein, the term “fluid” refers to gases, liquids, and combinations of gases and liquids, as well as to combinations of gases and solids, and combinations of liquids and solids.

### Description of Specific Embodiments

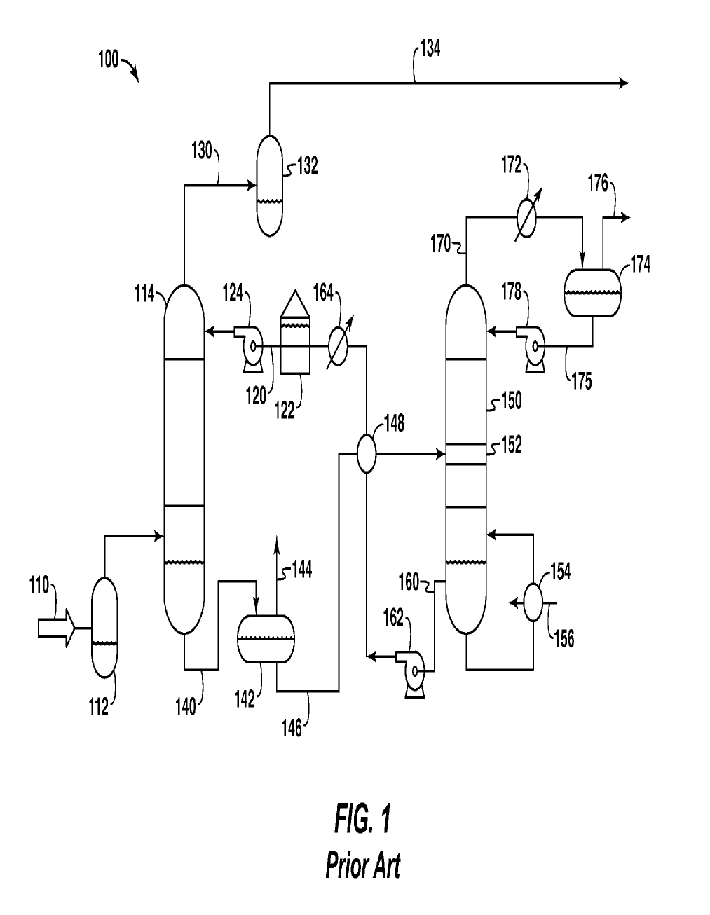

FIG. 1 demonstrates a known chemical solvent-based gas processing facility 100. The facility 100 operates to convert sour gas (shown at stream 110) to sweet gas (shown at stream 130). The sour gas stream 110 enters a contactor 114, while the sweet gas stream 130 exits the contactor 114.

It will be appreciated that FIG. 1 is a simplified schematic diagram intended to make clear only selected aspects of gas processing facility 100. A gas separation process will usually include many additional components such as heaters, chillers, condensers, liquid pumps, gas compressors, blowers, other types of separation and/or fractionation equipment, valves, switches, controllers, pressure-, temperature-, level-, and flow-measuring devices.

The gas stream 110 may be, for example, raw natural gas from a hydrocarbon recovery operation. The gas stream 110 contains at least one non-absorbing gas such as hydrocarbon gas. In addition, the gas stream 110 contains at least one acid gas. An example of an acid gas is carbon dioxide. A sour natural gas stream may have, for example, 1 to 10% H₂S and/or 1 to 10% CO₂, along with at least one hydrocarbon gas.

It should be recognized that the pressure of the gas stream 110 may vary considerably. Suitable pressures will range between atmospheric pressure and several thousand psig. However, for natural gas treating applications, it is particularly preferred that the gas stream 110 have a pressure of at least 100 psig, more typically at least 500 psig, even more typically at least 700 psig, and most typically at least 900 psig. Moreover, while it is generally contemplated that at least a portion of the gas pressure is due to the pressure of the gas stream 110 entering the gas treatment facility 100. It should also be recognized that, where appropriate, the pressure may also be increased using one or more compressors (not shown). In the case of CO₂ capture from flue gas, pressures will typically be very close to atmospheric pressure, though compressors may be used to increase the gas pressure somewhat.

Before entering the contactor 114, the sour gas stream 110 passes through an inlet separator 112. The inlet separator 112 serves to filter out impurities such as brine and drilling fluids. It will also remove any condensed hydrocarbons. Some particle filtration may also take place. It is understood that it is desirable to keep the gas stream 110 clean so as to prevent foaming of liquid solvent during the acid gas treatment process.

Upon exiting the contactor 114, the sweet gas stream 130 passes through an outlet separator 132. The outlet separator 132 allows any liquid solvent carried over from contactor 114 to fall out of the gas phase. The outlet separator 132 may also be used as a water wash vessel to capture vapor-phase solvent. The contactor 114 operates at a high pressure, such as between 800 and 1,000 psig. A final sweetened gas stream 134 is released from the outlet separator 132.

A lean solvent stream 120 also enters the contactor 114. The solvent stream 120 originates at a solvent tank 122 proximate to the contactor 114. Movement of the solvent stream 120 into the contactor 114 is aided by a pump 124 that moves the solvent stream 120 into the contactor 114 under suitable pressure. The pump 124 may, for example, boost pressure of the solvent stream 120 to 1,000 psig or higher. The solvent stream 120 may be a chemical solvent such as a secondary amine, a primary amine or a tertiary amine. The solvent stream 120 may also be an ionic liquid. For purposes of discussion, the solvent stream 120 may be interchangeably referred to herein as amine or a chemical solvent or a liquid solvent or an absorbing liquid.

Under certain circumstances, such as when dealing with flue gas which is generally at a low pressure, it may be advantageous to remove SO₂ from the gas stream 110 before entering the contactor 114. This is done by a separate process not shown or discussed herein. If SO₂ is present, it may form a heat-stable salt with amine in the contactor 114. The SO₂ may be removed using a specific solvent and a dedicated contactor. Also, corrosion inhibitors may be needed to retard the reaction of O₂ with the steel in the contacting process.

Once inside the contactor 114, gas from the gas stream 110 moves upward through the contactor 114. Typically, one or more trays or other internals (not shown) are provided within the contactor 114 to create indirect flow paths for the natural gas and to create interfacial area between the gas and liquid phases. At the same time, the liquid from the lean solvent stream 120 moves downward and across the succession of trays in the contactor 114. The trays aid interaction of the natural gas with the solvent stream 120.

The contactor 114 operates on the basis of a counter-current flow scheme. In this respect, natural gas is directed through the contactor 114 in one direction while chemical solvent is directed through the contactor 114 in the opposite direction. As the two fluid materials interact, the downflowing solvent absorbs H₂S and/or CO₂ from the upflowing sour gas to produce the sweetened gas stream 130. A rich solvent stream 140 then leaves the contactor 114. The rich solvent stream 140 defines an amine solution rich in the absorbed acid gases.

It is understood that a solvent may preferentially remove hydrogen sulfide molecules over carbon dioxide molecules. A tertiary amine typically will not effectively strip out CO₂ as quickly as H₂S. Therefore, two separate processing facilities 100 may be sequentially operated, with one being set to strip out primarily hydrogen sulfide and the other being designed to strip out primarily carbon dioxide. It may be advantageous to generate a CO₂ stream that is substantially free of H₂S.

The resultant “rich” solvent stream 140 is moved through a flash drum 142. The flash drum 142 operates at a pressure of about 100 to 150 psig. The flash drum 142 typically has internal parts that create a mixing effect or a tortuous flow path for the solvent stream 140 therein. Residual gases such as methane and CO₂ are flashed from the solvent stream 140 through line 144. The residual gases captured in line 144 may be reduced to an acid gas content of about 100 ppm if contacted with a small amount of fresh amine from line 120, for example. This concentration is small enough that the residual gases can be used as fuel gas for the facility 100.

The remaining rich solvent stream 146 is warm. However, it is desirable to further increase the temperature of the solvent stream 146 prior to regeneration. To accomplish this, the rich solvent stream 146 passes through a heat exchanger 148. The heat exchanger 148 allows the rich solvent stream 146 to be further warmed due to exposure to a hot, regenerated amine or solvent stream 160, discussed further below.

After passing through the heat exchanger 148, the rich solvent stream 146 is directed into a regenerator 150. The regenerator 150 is a large-diameter vessel that operates at a pressure of about 15 to 25 psig. The regenerator 150 defines a stripper portion 152 typically comprising trays or other internals (not shown) above a reboiler 154. A heat source 156 is provided to the reboiler 154 to generate vapor traffic within the regenerator 150. The reboiler 154 typically uses steam as its heat source to boil off water, H₂S and CO₂ from the amine.

The regenerator 150 produces a regenerated or “lean” solvent stream 160 that is recycled for reuse in the contactor 114. The lean solvent stream 160 exits the regenerator 150 and passes through the heat exchanger 148. The lean solvent stream 160 is at a temperature of about 265° F. Thermal contact with the rich solvent stream 146 in the heat exchanger 148 serves to partially cool the lean amine stream 160.

Stripped overhead gas from the regenerator 150 containing concentrated CO₂ (and H₂S, if present) exits the regenerator 150 as an impurities stream 170. The CO₂-rich impurities stream 170 is moved into a condenser 172. The condenser 172 serves to cool the impurities stream 170. The condenser 172 may be an air fan cooler or may be a heat exchanger using sea water. Cooling the impurities stream 170 serves to knock out water. This helps to minimize the required water make-up. Given the presence of acid gas and free water, this portion of the system is usually clad with high-alloy metal.

The cooled impurities stream 170 is moved through a reflux accumulator 174 that separates any remaining liquid from the impurities stream 170. A substantially pure acid gas stream 176 (saturated with water vapor) is then created. Where the acid gas stream 176 comprises CO₂, the CO₂ may be sequestered via compression. Where the acid gas stream 176 comprises H₂S, the H₂S may be converted into elemental sulfur at a sulfur recovery unit (not shown). In this instance, the reflux accumulator 174 may feed a so-called Claus process.

A “Claus process” is a process that is sometimes used by the natural gas and refinery industries to recover elemental sulfur from hydrogen sulfide-containing gas streams. Briefly, the Claus process for producing elemental sulfur comprises two primary sections. The first section is a thermal section wherein H₂S is converted to elemental sulfur at approximately 1,800-2,200° F. No catalyst is present in the thermal section. The second section is a catalytic section wherein elemental sulfur is produced at temperatures between 400° to 650° F. over a suitable catalyst (such as alumina). The reaction to produce elemental sulfur is an equilibrium reaction; hence, there are several stages in the Claus process where separations are made in an effort to enhance the overall conversion of H₂S to elemental sulfur. Each stage involves heating, reacting, cooling and separation.

As indicated in FIG. 1, water and some solvent may be dropped from the reflux accumulator 174. This results in a wet residual solvent stream 175. The residual solvent stream 175 is preferably carried through a pump 178 to boost pressure where it is then reintroduced into the regenerator 150. The residual solvent content will exit the regenerator 150 at the bottom as part of the lean solvent stream 160.

As it exits the regenerator 150, the lean solvent stream 160 is at a low pressure—about 15 to 25 psig. It is therefore desirable to raise the pressure of the lean solvent stream 160. Accordingly, the lean solvent stream 160 is passed through a lean solvent booster pump 162. From there, the lean solvent stream 160 passes through the heat exchanger 148 and then to a cooler 164. The cooler 164 ensures that the lean solvent stream 160 is not flashing before being returned to the solvent tank 122. In some cases, the solvent storage tank 122 is outside the circuit, in which case the lean solvent stream 160 will bypass the solvent tank 122 and pass directly to the pump 124. The cooler 164 will typically chill the lean solvent stream 160 down to 100° to 125° F.

The disadvantage of counter-current flow schemes such as that shown in the facility 100 of FIG. 1, and in particular in the contactor 114, is that comparatively low velocities are required to avoid entrainment of the downflowing liquid solvent in the gas 110. Also, relatively long distances are required for disengagement of the liquid droplets from the gas 110. Depending on the flow rate of the sour gas stream 110, the contactor 114 can be greater than 15 feet in diameter, and more than 100 feet tall. For high-pressure applications, the vessel has thick, metal walls. Consequently, counter-current contactor vessels can be very large and heavy. This is expensive and undesirable, particularly for offshore oil and gas recovery applications.

In the process 100 of FIG. 1, a single contacting tower 114 is shown. However, it is sometimes known to utilize more than one contacting tower 114 to extract impurities through the rich solvent stream 140. In either instance, the problem remains that the one or more contacting towers 114 tend to be very large. Stated another way, very large contactors are required for high-volume, high pressure applications. In the case of low-pressure applications such as CO₂ removal from flue gas at a power generating plant, it is estimated that a 50 foot by 50 foot duct contactor would be required even for a relatively small, 500 megawatt power plant flue gas application. Many hundreds of gallons per minute of solvent would also be required to flow through the contactor 114.

Therefore, it is desirable to reduce the size of the tower and equipment associated with the contacting process. It is further desirable to utilize a series of low pressure-drop, small contacting devices to remove CO₂ from flue gas.

It is proposed herein to utilize a co-current flow scheme as an alternative to the counter-current flow scheme demonstrated in the one or more contacting towers 114. The co-current flow concept utilizes two or more contactors in series wherein a sour gas stream and a liquid solvent move together within the contactors. In one embodiment, the sour gas stream and the liquid solvent move together generally along the longitudinal axis of the respective contactors. Co-current flow contactors can operate at much higher fluid velocities. As a result, co-current flow contactors tend to be smaller than counter-current flow contactors (such as contactor 114) that utilize standard packed or trayed towers.

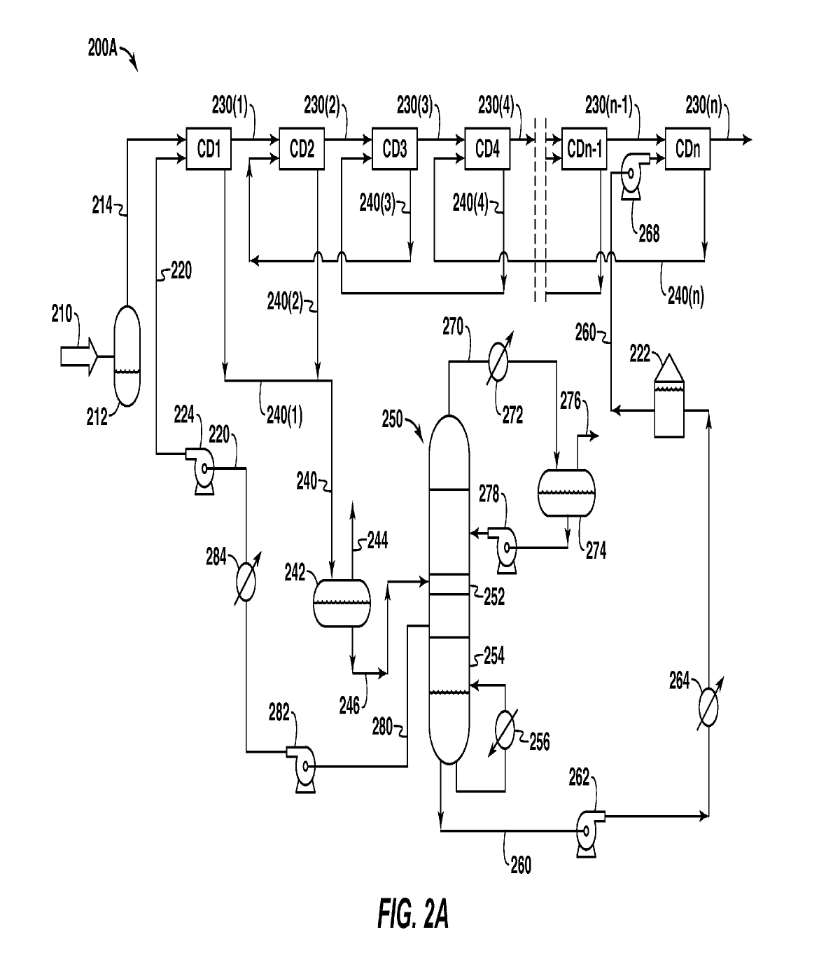

Two separate arrangements for gas processing facilities are shown which employ co-current flow contactors. These are seen in FIGS. 2A and 2B. Each figure presents a schematic view of a gas processing facility 200A, 200B, for the removal of CO₂ or other acid gases from a gas stream 210. The gas processing facilities 200A, 200B present alternatives for a sweetening facility to the facility 100 shown in FIG. 1.

In each of FIGS. 2A and 2B, the gas stream 210 may be a gas stream incident to a hydrocarbon production operation. Alternatively, the gas stream 210 may be a flue gas stream from a power plant, or a synthesis gas stream (so-called “syn-gas”). Alternatively, the gas stream may be a flash gas stream taken from a flash drum in a gas processing facility itself. It is noted that where syn-gas is used, the gas will need to be cooled and undergo solids filtration before introduction into the facility 200A or 200B. Alternatively, the gas stream 210 may be a tail gas stream from a Claus sulfur recovery process or an impurities stream from a regenerator. Alternatively still, the gas stream 210 may be a CO₂ emission from a cement plant or other industrial plant. In this instance, CO₂ may be absorbed from excess air or from a nitrogen-containing flue gas.

The natural gas stream 210 contains at least one non-absorbing gas such as a hydrocarbon gas or nitrogen. The gas stream 210 also contains an acid gas. The acid gas may be, for example, carbon dioxide or hydrogen sulfide. The gas processing facilities 200A, 200B operate to convert the gas stream 210 into sweet gas (shown at final stream 230(n)) by removal of the acid gas content.

In operation, the initial gas stream 210 enters a first co-current separator, or contacting device, CD1 where it is mixed with a liquid solvent 220. The solvent 220 preferably consists of an amine solution such as monoethanol amine (MEA) or diethanol amine (DEA). However, other solvents such as ionic liquids may be used.

In accordance with the present disclosure and as discussed further below, each of the gas processing facilities 200A, 200B employs a series of co-current contactors CD1, CD2, . . . , CD(n−1), CDn. Each contactor removes a portion of the acid gas content from the gas stream 210, thereby releasing a progressively sweetened gas stream. The final contactor CDn provides a final sweetened gas stream 230(n).

Before entering the first contactor CD1, the gas stream 210 passes through an inlet separator 212. The inlet separator 212 serves to filter out impurities such as brine and drilling fluids. Some particle filtration may also take place. It is understood that it is desirable to keep the gas stream 210 clean so as to prevent foaming of solvent during the acid gas treatment process.

It is noted here that some pretreatment of the gas stream 210 may be desirable before entering the first contactor CD1 or even the inlet separator 212. For example, the gas stream 210 may undergo a water wash to remove glycol or other chemical additives. This may be done through a separate processing loop (not shown) wherein water is introduced to the gas, such as via a co-current contactor. Water has an affinity for glycol and will pull the glycol out of the natural gas. This, in turn, will help control foaming within the contacting devices CD1, CD2, . . . CDn. In the case of flue gas applications, corrosion inhibitors may need to be added to the solvent to retard the reaction of O₂ with the steel in the processes.

Referring specifically to FIG. 2A, a liquid solvent stream 220 also enters the first contactor CD1. The solvent stream 220 is a partially regenerated solvent produced by a regenerator 250. Movement of the “semi-lean” solvent stream 220 into the first contactor CD1 is aided by a pump 224. The pump 224 moves the semi-lean solvent stream 220 into the first contactor CD1 under suitable pressure. An example of a suitable pressure is about 15 psia to 1,500 psig.

Once inside the first contactor CD1, the gas stream 210 and the chemical solvent stream 220 move along the longitudinal axis of the first contactor CD1. As they travel, the liquid amine (or other solvent) interacts with the CO₂ (or other acid gas) in the gas stream 210, causing the CO₂ to chemically attach to or be absorbed by amine molecules. A first “rich” solvent solution 240(1) drops out of a bottom of the first contactor CD1. At the same time, a first partially-sweetened gas stream 230(1) moves out of a top portion of the first contactor CD1 and is released from a second contactor CD2.

The second contactor CD2 also represents a co-current, separating device. Optionally, a third co-current separating device CD3 is provided after the second contactor CD2. Each of the second and third contactors CD2, CD3 generates a respective partially-sweetened gas stream 230(2), 230(3). In addition, each of the second and third contactors CD2, CD3 generates a respective partially-loaded gas-treating solution 240(2), 240(3). Where an amine is used as the solvent, the partially-loaded gas-treating solutions 240(2), 240(3) will comprise rich amine solutions. In the illustrative facility 200A, the second loaded gas-treating solution 240(2) merges with the first loaded gas-treating solution 240(1) and goes through a regeneration process, including going through regenerator 250.

It is noted that as the gas 214 moves through the progressively-sweetened gas streams 230(1), 230(2), . . . 230(n−1) in a downstream direction, pressure in the system will generally decrease. As this happens, the pressure in the progressively-richer amine (or other liquid solvent) streams 240(n), 240(n−1), . . . 240(2), 240(1) in the upstream direction needs to generally increase to match the gas pressure. It is thus preferred in facility 200A that one or more small booster pumps (not shown) be placed between each of the contactors CD1, CD2, . . . . This will serve to boost liquid pressure in the system.

In the facility 200A, the regeneration process is similar to the process from the facility 100 of FIG. 1. In this respect, the streams 240(1), 240(2) comprise “rich” solvent solutions that are first moved through a flash drum 242. Residual natural gas may be flashed from the solvent stream 240 through line 244. The resulting rich solvent stream 246 is directed into a regenerator 250.

The rich solvent stream 246 is preferably moved through a heat exchanger 248. (An exemplary heat exchanger is shown at 248 in connection with facility 200B of FIG. 2B.) The relatively cool (close to ambient temperature) solvent stream 246 is heated via contact with a warm lean solvent stream 260 through heat exchanger 248. This, in turn, serves to beneficially cool the lean solvent stream 260 before delivery to a lean solvent cooler 264, thence to a final contactor CDn as the regenerated liquid solvent stream.

The regenerator 250 defines a stripper portion 252 comprising trays or other internals (not shown) above a reboiler 254. A heat source 256 is provided with the reboiler 254 to generate heat. The regenerator 250 produces the regenerated or “lean” solvent stream 260 that is recycled for reuse in the final contactor CDn. Stripped overhead gas from the regenerator 250 containing concentrated CO₂ (and H₂S, if present in the raw gas) exits the regenerator 250 as an impurities stream 270 (not labeled in FIG. 2B).

The CO₂-rich impurities stream 270 is moved into a condenser 272. The condenser 272 serves to cool the impurities stream 270. The cooled impurities stream 270 is moved through a reflux accumulator 274 that separates any remaining liquid (mostly condensed water) from the impurities stream 270. A substantially pure acid gas stream 276 is then created. Where the acid gas stream 276 comprises CO₂, the CO₂ may be used as part of a miscible oil recovery operation to recover oil, while storing the bulk of the CO₂ in a reservoir. If the oil reservoir to be flooded is “sweet” (i.e., doesn't contain significant H₂S or other sulfurous compounds), the CO₂ to be used for enhanced oil recovery (“EOR”) should likewise be substantially “sweet.” However, concentrated CO₂ streams from oil and gas production operations may be contaminated with relatively small amounts of H₂S. Thus, it is desirable to remove the H₂S from the CO₂ unless the acid gas is injected purely for geologic sequestration.

Where the acid gas stream 276 comprises H₂S, the H₂S may be converted into elemental sulfur using a sulfur recovery unit (not shown). The sulfur recovery unit may be a so-called Claus process. This enables more efficient sulfur recovery for large quantities of sulfur.

As indicated in the facilities 200A, 200B of FIGS. 2A and 2B, some liquid may be dropped from the reflux accumulator 274. This results in a residual liquid stream 275. The residual liquid stream 275 is preferably carried through a pump 278 to boost pressure where it is then reintroduced into the regenerator 250. The residual liquid will exit the regenerator 250 at the bottom as part of the lean solvent stream 260. Some water content may optionally be added to the lean solvent stream 260 to balance the loss of water vapor to the sweetened gas streams 230(n−1), 230(n). This water may be added at the intake or suction of the reflux pump 278.

The lean or regenerated solvent stream 260 is at a low pressure. Accordingly, the regenerated solvent stream 260 is carried through a pressure boosting pump 262. Pump 262 is referred to as a lean solvent booster 262. From there, the lean solvent stream 260 passes through a cooler 264. Cooling the solvent via cooler 264 ensures that the lean solvent stream 260 will absorb acid gases effectively. The chilled lean solvent stream 260 is used as the solvent stream for the last separating contactor CDn.

A solvent tank 222 is optionally provided proximate the first contactor CD1. The lean solvent stream 260 may pass through the solvent tank 222. More preferably, the solvent tank 222 is off-line and provides a reservoir for solvent as it may be needed for the gas facility 200A.

As noted, the facilities 200A and 200B each employ a plurality of co-current contactors CD1, CD2, . . . CD(n−1), CDn, in series. Each co-current contactor receives a gas stream that includes a hydrocarbon gas and an acid gas, or a flue gas containing CO₂. Each contactor CD1, CD2, . . . CD(n−1), CDn operates to produce a progressively sweetened gas stream.

The co-current contacting devices CD1, CD2, . . . CD(n−1), CDn may be any of a variety of short-contact time mixing devices. Examples include static mixers and centrifugal mixers. Some mixing equipment breaks the liquid apart through an eductor. The eductor delivers gas through a venturi-like tube that in turn pulls liquid solvent into the tube. Because of the venturi effect, the liquid solvent is dragged in and broken into small droplets, allowing a large surface area of contact with the gas. Alternatively, the motive power of the liquid can be used to educt, or pull the gas in. Motive power may be particularly useful in low pressure applications such as CO₂ removal from flue gas.

One preferred contacting device is the ProsCon™ contactor. This contactor utilizes an eductor followed by a centrifugal coalescer. The centrifugal coalescer induces large centrifugal forces to re-integrate the liquid solvent in a small volume. In whatever embodiment, compact vessel technology is preferably employed, allowing for a reduction of the hardware in comparison to the large columned contactors 114.

The first contactor CD1 receives the raw gas stream 210. The gas stream 210 is treated in the first contactor CD1 for the removal of acid gas. A first partially-sweetened gas stream 230(1) is then released. The first partially-sweetened gas stream 230(1) is delivered to the second contactor CD2. There, the first sweetened gas stream 230(1) is further treated for the removal of acid gas so that a second, more-fully sweetened gas stream 230(2) is released. This pattern is continued such that a third contactor CD3 produces a more fully-sweetened gas stream 230(3); a fourth contactor CD4 produces still an even more-sweetened gas stream 230(4); and a next-to-last contactor produces yet a more sweetened gas stream CD(n−1). Each of these may be referred to as a “subsequent” sweetened gas stream.

A final sweetened gas stream 230(n) is released by the final contactor CDn. The final sweetened gas stream 230(n) is a commercial product that has been processed to within a desired standard. The final sweetened gas stream 230(n) may be delivered or sold for residential or commercial use. The number of contacting devices (at least two) prior to the final contactor CDn is dictated primarily by the level of CO₂ (or other acid gas) removal needed to meet the desired standard.

In one aspect, a combination of a mixing device and a corresponding coalescing device is employed in each contactor. Thus, for example, the first CD1 and second CD2 contactors may utilize static mixers as their mixing devices, while the third CD3 and other CD4 contactors may utilize eductors, and while the CDn−1, CDn contactors may utilize centrifugal mixers. Each contactor has an associated coalescing device. In any embodiment, the gas streams 214, 230(1), 230(2), . . . 230(n−1) and the co-currently flowing liquid solvent streams flow through the contactors CD1, CD2, . . . CDn in the same direction. This allows a short time period for the treatment reactions to take place, perhaps even as short as 100 milliseconds or less. This can be advantageous for selective H₂S removal (relative to CO₂), as certain amines react more quickly with H₂S than with CO₂.

It is preferred that each contacting device CD1, CD2, . . . CDn includes an “atomization” section which divides the liquid solvent into a large number of small droplets. This increases the surface area available for contact between the gas streams 214, 230(1), 230(2), . . . 230(n−1) and the co-flowing liquid solvent. Atomization also decreases the distances required for diffusion of acid gas components in both the vapor and liquid phases. For fast chemical reactions, near-equilibration is possible in this short time period.

In addition to receiving a gas stream, each co-current contactor CD1, CD2, . . . CD(n−1), CDn also receives a liquid solvent stream. In the facilities arrangement 200A of FIG. 2A, the first contactor CD1 receives a partially-regenerated solvent stream 220. Thereafter, subsequent contactors CD2, CD3, CD(n−1), CDn receive loaded solvent solutions released from the succeeding respective contactor. Thus, the second contactor CD2 receives partially-loaded solvent solution 240(3) released from the third contactor CD3; the third contactor CD3 receives a partially-loaded solvent solution 240(4) released from the fourth contactor CD4; and the next-to-last contactor CD(n−1) receives a partially-loaded solvent solution 240(n) from the final contactor CDn. Stated another way, the liquid solvent received into the second contactor CD2 comprises the partially-loaded solvent solution 240(3) released from the third contactor CD3; the liquid solvent received into the third contactor CD3 comprises the partially-loaded solvent solution 240(4) released from the fourth contactor CD4; and the liquid solvent received into a next-to-last contactor CD(n−1) comprises the a partially-loaded solvent solution 240(n) from the final contactor CDn. Thus, the partially-loaded solvent solutions are introduced into the contactors CD1, CD2, CD3, . . . CDn in a processing direction opposite that of the progressively sweetened gas streams 230(1), 230(2), 230(3), . . . 230(n−1).

Operation of the gas processing facility 200B of FIG. 2B is similar to that of the facility 200A of FIG. 2A. However, in facility 200B the first contactor CD1 receives the liquid solvent from the second contactor CD2. This means that facility 200B does not include the semi-lean solvent stream 280. The liquid solvent from the second contactor CD2 is referenced as solvent line 240(2). Solvent line 240(2) represents a solvent solution created from the treatment of sweetened gas stream 230(1) within the second contactor CD2.

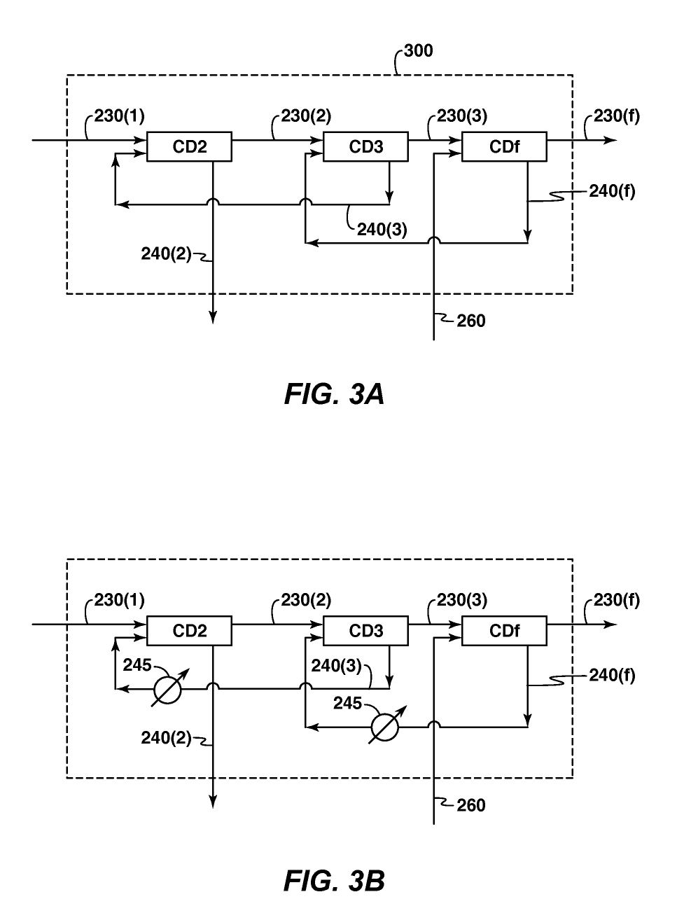

Because the liquid solvent 240(2) received by the first contactor CD1 in FIG. 2B has already been processed through at least one if not multiple contactors, the liquid solvent 240(1) received by the first contactor CD1 may be very rich. For this reason, it may be desirable to provide some level of intermediate processing of the solvent solution. This is described below in connection with FIG. 4.

Alternatively, a “semi-lean” gas stream could be taken from other sweetening operations in the gas facility 200A or 200B and used, at least in part, as an amine solution for the first CD1 or second CD2 contactor. In this respect, there are situations in which a single type of solvent is used for more than one service in a gas treating facility. This is referred to as integrated gas treatment. For example, MDEA may be used both for high-pressure, H₂S-selective acid gas removal, as well as in a Claus Tail Gas Treating (TGT) process. The “rich” amine from the TGT process is not heavily loaded with H₂S and CO₂, owing to the low pressure of the process. Thus, in one embodiment herein the “rich” stream from the TGT process is used as a “semi-lean” stream for first CD1 or second CD2 contactor. The “semi-lean” stream (not shown) is pumped to pressure and injected into the first CD1 or second CD2 contactor, possibly along with solvent from the succeeding respective contactor.

In both gas processing facilities 200A, 200B, the last separating contactor CDn also receives a liquid solvent. The liquid solvent is the regenerated solvent stream 260. Regenerated solvent stream 260 is highly lean.

As indicated, the co-current contactors CD1, CD2, . . . CD(n−1), CDn release a progressively sweetened gas stream 230(1), 230(2), . . . 230(n−1), 230(n) in a first processing direction. The contactors CDn, CD(n−1), . . . CD3, CD2, CD1 also release or deliver progressively richer solvent solutions 240(n), 240(n−1), . . . 240(2), 240(1) in a second opposite processing direction. In the facility 200B, the leanest liquid solvent is delivered from the regenerator 250 into the final contactor CDn as the lean solvent stream 260. The next cleanest liquid solvent is the final solvent solution 240(n); the next cleanest liquid solvent is solvent solution 240(n−1); and working back to the first solvent solution 240(1). As discussed above, solvent solution 240(1) is sent to the regenerator 250.

As noted, in the facilities arrangement 200A of FIG. 2A, both solvent solutions 240(2) and 240(1) undergo regeneration. As shown in FIG. 2A, partially regenerated solvent 280 comes out of the regenerating vessel 250. The solvent 280 is placed under pressure through booster pump 282. From there, the solvent 280 is cooled in heat exchanger 284 to become solvent stream 220. The solvent 280 is further pressurized through booster pump 224 before being introduced into the first co-current contactor CD1.

The combined solvent solutions 240(1), 240(2) have been coalesced using mist eliminators or electrostatic precipitators in CD1 and CD2, respectively. Device 242 may be a large flash drum to recover light hydrocarbons from the rich amine. A flashed rich solvent stream 246 is obtained.

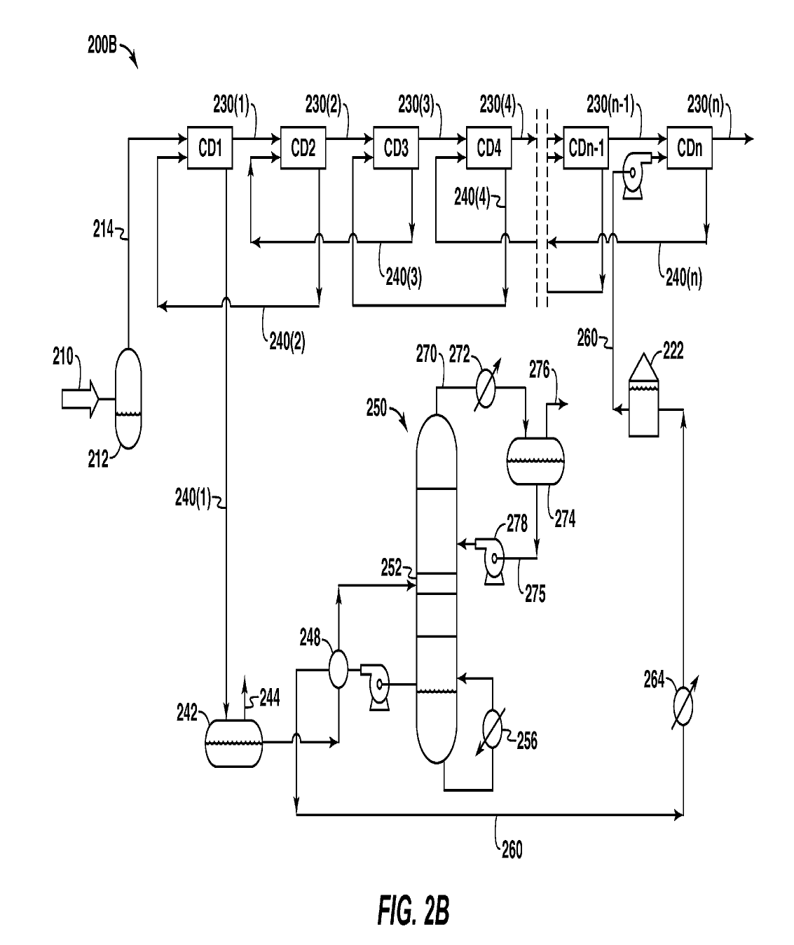

Those of ordinary skill in the art of gas processing will understand that the absorption of acid gases into amine (or other chemical solvent) is an exothermic process. The heat that is generated raises the temperature of the partially-loaded solvent solutions 240(2), 240(3), . . . 240(n). This, in turn, reduces the capacity of the solvent to absorb H₂S and CO₂. To counter this effect, and in one embodiment of the facility 200A, the solvent solutions 240(2), 240(3), . . . 240(f) are cooled between stages, as shown in FIG. 3.

Another option for countering the effect of heat release is to place one or more of the co-current contacting devices CD1, CD2 inside of a shell. In one aspect, the first contacting device CD1 and the second contacting device CD2 are together placed in a shell before being sent to the regenerator 250. A cooling medium is then circulated within the shell.

FIG. 3A provides a schematic view of a shell 300. The shell 300 may be a permanent, climate-controlled structure. Alternatively, the shell 300 may be a temporary or portable structure. Alternatively still, the shell 300 may be an insulated jacket. In any instance, the shell 300 is part of the gas processing facility such as facility 200B that utilizes a plurality of co-current contacting devices in series. In the illustrative arrangement of FIG. 3, a second contacting device CD2, a third contacting device CD3 and a final contacting device CDf are provided, each residing within the single shell 300.

In the view of FIG. 3A, gas streams 230(2) and 230(3) are seen carrying sweetened gas away from the respective second CD2 and third CD3 contacting devices. In addition, the final contacting device CDf generates a final sweetened gas stream 230(f). The contacting devices CD2, CD3 and CDf also generate respective rich solvent solutions 240(2), 240(3) and 240(f). The third rich solvent solution 240(3) is directed back to the second contacting device CD2 as a liquid solvent while the final rich amine solution 240(f) is directed back to the third contacting device CD3.

The shell 300 is designed to keep the equipment and the solvent solutions flowing therein cool. This may be done through climate control within the shell 300 or through the circulation of a cooling medium adjacent to the equipment.

It is noted in FIG. 3A that the second solvent solution 240(2) is shown extending out of the shell 300. In practice, second solvent solution 240(2) may be returned to a regenerator such as regenerator 250 shown in FIGS. 2A, or may serve as a liquid solvent for a preceding contacting device such as first contacting device CD1 of FIG. 2B.

In another embodiment (not shown in the Figures), each of the contacting devices CD1, CD2, . . . CDn may be individually fitted inside of a jacket. A cooling medium is then circulated within the jacket. The jacket may be, for example, a carbon steel shell. The cooling medium allows heat exchange to take place, thereby reducing the temperature of the rich solvent solutions therein.

FIG. 3B provides another schematic view of a portion of the gas processing facility 200A of FIG. 2A. Here, dedicated coolers 245 are used for cooling the solvent solutions 240(3) and 240(f). The use of heat-exchanging coolers 245 would typically be in lieu of one or more shells.

Another feature that may be provided in the facility 200A is to provide a flash drum in one or all of the solvent solution return lines 240(1), 240(2), 240(3), 240(4), . . . 240(n). FIG. 4 is a schematic view of a portion of the gas processing facility 200A of FIG. 2A, in another embodiment. Here, a flash drum 247 is placed along the third solvent solution stream 240(3). A flash line 248 is provided coming off of the top of the flash drum 247. The flash drum 247 and associated flash line 248 permit methane and some CO₂ absorbed in the solvent within the solvent solution line 240(3) to be flashed out before the solvent solution returns to the second contactor CD2. H₂O in vapor form may also vent from the flash line 248. Flashing creates a “semi-lean” solvent solution. This not only improves efficiency in the respective contactors CD2, CD3, . . . CDn, but also reduces the load on the thermal regenerator 250.

In the arrangement where a flash drum 247 is used, gas flashing out of the flash line 248 (comprising CH₄, CO₂ and H₂O) would preferably be merged with gas 244 from flash tank 242, for example. The pressure would preferably match the pressure of CH₄/CO₂ coming off of the flash tank 242. Pressure of the impurities line 270 from regenerator 250 is typically at around 15 psig, and it contains primarily CO₂ and H₂S (if present in the raw gas), with very little CH₄. As such, this stream can be further compressed and injected downhole, or it can be processed to generate sulfur from the H₂S.

Another feature that may be provided in the facility 200 is to provide a pressure boost along one or all of the solvent solution return lines 240(3), 240(4), . . . 240(n). In the illustrative arrangement of FIG. 4, a pump 249 is shown in line 240(3) following the flash drum 247. Compression of the solvent solution return such as in line 240(3) overcomes pressure drop in the system along the compact contacting devices CD1, CD2, . . . CDn. This, in turn, helps the solvent solution entrain the acid gases.

Another feature that may be provided in the facility 200 is to provide a water wash operation. The water wash operation would preferably be provided for the final sweetened gas stream 230(n). The water wash operation allows the recovery of any liquid solvent that remains entrained within the final sweetened gas stream 230(n). This is particularly an issue when a more volatile amine such as MEA or FLEXSORB® is used as the solvent. Make-up water for the system may be first introduced through the water wash system. The diluted amine may then be pumped to the main amine circuit.

The use of multiple co-current separators in series has been described herein in connection with the removal of acid gases from a gas stream. FIGS. 2A and 2B show applications where CO₂ (or other acid gas) is removed down to sequentially lower concentrations through a plurality of contacting devices CD1, CD2, . . . CDn. However, the facility 200, and particularly the use of a plurality of co-current contactors in series, may be used for other applications.

One such application involves the selective removal of H₂S from the impurities stream 270 at the end of the regeneration process. This may be referred to as acid gas enrichment, or “AGE.” The AGE process is useful where a concentrated CO₂ stream from a gas processing operation is contaminated with a relatively small amount of H₂S. Thus, it is desirable to remove the H₂S from the CO₂ through a series of contacting devices using selective amine solvent to perform the separation. Preferred amines include tertiary amines like methyl diethanol amine (MDEA) or hindered amines such as FLEXSORB®. Alternatively, the utilization of a reactive solvent like chelated iron solution may be beneficial.

In operation of an AGE process, multiple co-current separators are provided along impurities line 270 for the sequential removal of H₂S after the liquid solvent has been separated. This generally involves selective H₂S removal from a low-pressure, high-CO₂ content stream. This application generally operates at a much lower pressure, e.g., about 15 psig, than acid gas removal from the natural gas stream 210, which preferably operates at about 800 to 1,000 psig.

The AGE process generates a first gas stream having an increased concentration of H₂S. This first stream comes from the regeneration of the AGE solvent, and is sent to a sulfur recovery unit. The AGE process generates a second gas stream comprised primarily of CO₂ and water vapor. In some instances, the second gas stream may also contain mercaptans picked up by the acid gas removal process, but not picked up by the AGE solvent. In this instance, it may be desirable to absorb these sulfur-containing compounds using a physical solvent like Selexol®. This too could be accomplished through a series of co-current contacting devices. The recovered sulfur-containing compounds could be sent to a sulfur recovery unit.

The use of multiple co-current separators in series may also be used in connection with regeneration. Regeneration is the process whereby H₂S and/or CO₂ are removed from “rich” solvent by decreasing its pressure and/or increasing its temperature. This is typically done in a trayed tower as is represented by regenerator 250 of FIG. 2A. However, regeneration is also disclosed herein through the use of the co-current contactors. In this operation, the rich amine solution 246 is taken through a series of contactors.

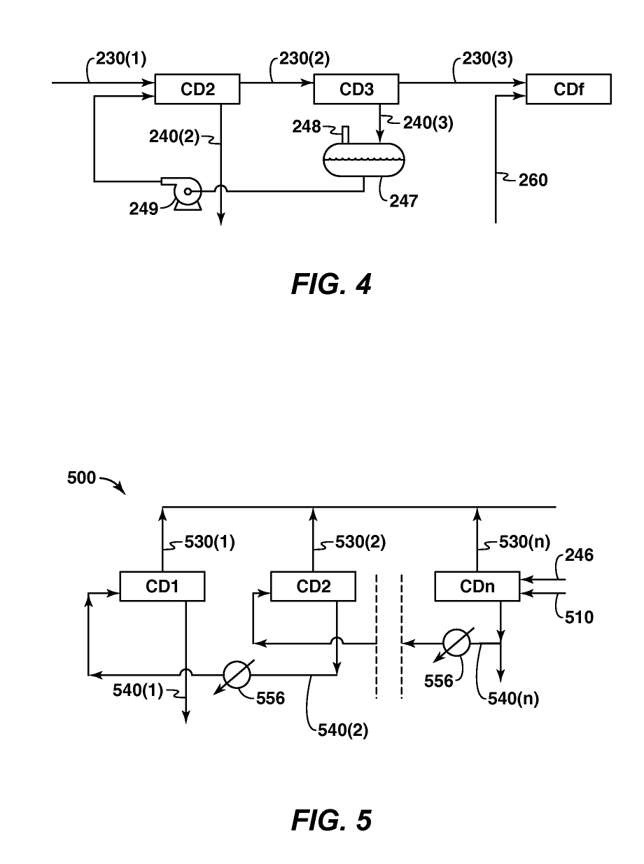

FIG. 5 is a schematic view of a gas regeneration facility 500. The facility 500 uses a series of co-current contactors CD1, CD2, . . . CDn for the removal of acid gas from a rich solvent solution. In FIG. 5, the rich solvent solution comes in at 246. This matches with rich solvent solution 246 of FIG. 2A.

The rich solvent solution 246 is warm due to the exothermic chemical reaction involved in the earlier CO₂ removal process, and possible pre-heating with an outside source. The rich solvent solution 246 is introduced into an nth contacting device CDn. In the nth contacting device CDn, the rich solvent solution 246 is contacted with a stripper gas 510. The stripper gas 510 may be nitrogen, or air, as long as H₂S is not present in the solvent. In this case, the stream may be vented to the atmosphere. Fuel gas may be used if only traces of H₂S are present. In this case, the stream may be returned to the fuel gas system. If H₂S is present, the preferred stripping gas would be steam. In this case, the spent stream could be condensed, and the remaining vapor sent to a sulfur recovery unit, or an acid gas injection unit. Acid gas, e.g., CO₂ or H₂S vapor, flashes off as acid gas stream 530(n). At the same time, an nth solvent stream 540(n) is generated.

This nth solvent stream 540(n) is heated using a heater 556. The nth solvent stream 540(n) is then introduced into the next contactor in a series of co-current contactors. In the arrangement of FIG. 5, the next contactor is a second contacting device CD2. However, it is understood that any number of intermediate contacting devices may be provided in the regeneration facility 500, depending on the degree of acid gas removal desired.

At the second contacting device CD2, acid gas again flashes off, this time as acid gas stream 530(2). At the same time, a second lean solvent stream 540(2) is generated. This second lean solvent stream 540(2) is preferably heated using a heater 556 and then introduced into a final contactor, indicated as first contacting device CD1. Acid gas flashes from first contacting device CD1 as acid gas stream 530(1). At the same time, a lean solvent solution 540(1) is ultimately regenerated. The lean solvent solution 540(1) may be introduced into contactor CDn of facility 200 as lean solvent stream 260.

It can be seen that the solvent regeneration process described in connection with FIG. 5 is essentially the reverse of the sweetening process described above in connection with FIGS. 2A and 2B.

Referring again to FIG. 2A, in some CO₂ removal processes it may be desirable to allow a small percentage of CO₂ molecules to ultimately pass to the sweetened gas stream 230(n). This can be done by taking advantage of the difference in the rate of reaction between (1) H₂S and certain amines, particularly tertiary and hindered amines, and (2) CO₂ and those same amines.

As noted, there are several different types of amines generally used in sour gas treatment. General examples are secondary and primary amines. Secondary amines have one hydrogen atom attached to the nitrogen atom. Examples are dimethyl amine, methylethanolamine, and diethanol amine (DEA). Primary amines have two hydrogen atoms attached to the nitrogen atom. Examples are methyl amine and monoethanol amine (MEA). Other amines include diisopropyl amine (DIPA) and aminoethoxyethanol (Diglycolamine®, or “DGA”).

Tertiary, secondary and primary amines all react quickly with H₂S according to the following two-step process:

H₂O+H₂S⇄H⁺+HS⁻ (1)

NR₁R₂R₃+H⁺+HS⁻→NHR₁R₂R₃⁺+HS⁻ (2)

wherein: N is nitrogen, and
R₁, is an organic group and R₂, R₃ are organic groups or hydrogen atoms attached to the nitrogen.

Amines can react with CO₂ via two different routes. If the amine has one hydrogen atom (a secondary amine) or two hydrogen atoms (a primary amine attached to the nitrogen atom), a carbamate may be formed. This works in accordance with the following process:

CO₂+2R₁R₂NH⇄(R₁R₂NH₂⁻)(R₁R₂HCOO⁻) (3)

The reaction (3) is relatively fast. For this reason secondary and primary amines are preferred for CO₂ absorption. However, a maximum theoretical loading of only 0.5 mole CO₂/mole amine is possible.

Another type of amine is the tertiary amine. Tertiary amines have no hydrogen atoms directly attached to the nitrogen atom and therefore cannot form carbamates. An example of a tertiary amine is methyl diethanol amine (MDEA).

All amines, including MDEA, can react with CO₂ via bicarbonate formation. These include secondary amines, primary amines and tertiary amines. The bicarbonate reaction occurs according to the following general process:

H₂O+CO₂⇄[H₂CO₃] (4)

[H₂CO₃]⇄H⁺+HCO₃⁻ (5)

NR₁R₂R₃+H⁺+HCO₃⁻⇄NHR₁R₂R₃⁺+HCO₃⁻ (6)

It is noted though that the formation of bicarbonate (HCO₃⁻) is relatively slow.

In some instances a tertiary amine is preferred. This circumstance may arise because of lower corrosivity requirements or lower regeneration energy requirements. In this instance, an activator may be added to an MDEA amine solution to speed up the CO₂ absorption. An example of a suitable activator is Piperazine.

A benefit of tertiary amines is that they can be used to preferentially remove H₂S to low levels while allowing some of the CO₂ to “slip” to the treated or “sweet” gas stream 230(n). Limiting the contact time between the tertiary amine and the gas allows H₂S absorption (via reactions (1) and (2)) to reach equilibrium, while CO₂ absorption (via reactions (4)-(6) only) does not have sufficient time to reach equilibrium. A suitable tertiary amine for this operation is MDEA. To further enhance the selectivity of the amine toward H₂S molecules, an inorganic salt may be dissolved into the initial amine solution 220. An example of an inorganic salt is phosphate. The inorganic salt retards the formation of bicarbonate ions.

Other types of amines may be used for selective H₂S removal. Examples are the so-called “hindered” amines such as ExxonMobil Corporation's FLEXSORB®. The “hindered” amines are primary or secondary amines. However, the hindered amines inhibit carbamate formation by having a large, bulky substituent, that is, an atom or group of atoms substituted in place of a hydrogen atom, adjacent to the nitrogen atom. Since the hindered amines are primary or secondary amines, they are stronger bases and tend to be even more selective to H₂S over CO₂. Alternatively, a physical solvent with H₂S-selective attributes (like Selexol®) may be used. Thus, in one aspect of the present inventions, the solvent preferentially absorbs H₂S, allowing CO₂ to slip to the final sweetened gas stream 230(n). A more concentrated H₂S stream is then generated from the regenerator 250 (i.e., stream 276) that may be used, for example, for sulfur recovery. The CO₂ component may optionally be removed through a subsequent acid gas removal process using a liquid solvent that more aggressively absorbs carbon dioxide molecules. The CO₂ regenerated from the second solvent is substantially free of H₂S and thus may be used for enhanced oil recover (EOR).

Regardless of the type of solvent used, the H₂S selectivity may be enhanced by lowering the temperature of the solvent. In one aspect, different contactors CD1, CD2, etc. are operated at different temperatures. For example, the first contactor CD1 may be operated at a lower temperature than a final contactor CDn, inasmuch as the first contactor may be using a richer liquid solvent 240(2) (as in FIG. 2B).

It may also be desirable to change the number of stages or contactors needed for contacting the gas, due to long-term changes in flow rate, or composition of the initial gas stream 210. The modular nature of the contactors CD1, CD2, . . . CDn within the facility 200 is attractive for applications where there may be large changes in conditions over the life of the operation.

Another application of the use of multiple co-current contactors in series involves the selective removal of H₂S from Claus Tail gas. This is also typically a low-pressure application, that is, about 15 psig. If a relatively large amount of H₂S is present in the enriched acid gas stream 246 or in the impurities stream 270, conversion of the H₂S to elemental sulfur can be done via the Claus reaction. The “tail gas” from the Claus process, which contains H₂S, SO₂, CO₂, N₂ and water vapor, can be reacted to convert the SO₂ to H₂S via hydrogenation. The hydrogenated tail gas has a modest partial pressure and significant amount (perhaps more than 50%) of CO₂, and a few percent or less of H₂S. This type of stream, which is typically near atmospheric pressure, is amenable to selective H₂S removal, as described above. This is used to recover large fractions of the H₂S. The recovered H₂S may be recycled to the front of the Claus unit or sequestered downhole. Alternatively, a direct oxidation of the H₂S to elemental sulfur may be performed using various processes known in the field of gas separation.

Another application involves flash gas conditioning. This means that multiple contacting devices may be employed in series to remove impurities from the gas in line 244. This is a relatively low-pressure application, operating at about 100 to 150 psig. Only 2 or 3 stages are anticipated as being necessary, as the H₂S specification for flash gas is generally not as stringent as that for pipeline gas. In this respect, the flash gas is used as fuel gas within the gas processing facility 200A or 200B and is not commercially sold.

In yet another application, the gas stream may represent gas from a catalytic hydrodesulfurization process, or “CHDS.” In oil refineries, CHDS is sometimes used to convert mercaptans, sulfides, thiophenes, and other sulfur-containing compounds to H₂S. As an incidental byproduct of the CHDS, light hydrocarbons may be produced. It is possible to treat this gas to remove the H₂S, then use the treated gas as fuel, for example. Such treatment may be through a series of co-current contactors as described above.

A number of methods have been demonstrated herein for sequentially removing acid gases from a raw gas stream by using two or more contactors in series. Embodiments of some methods herein involve the removal of acid gases, either partially or completely, and either selectively or non-selectively, from hydrocarbon gas or liquid streams.

Various absorbent liquids may be used to remove, for example, CO₂ from a gas stream. The gas stream may be a natural gas stream, a combustion exhaust gas stream or a refining gas stream. The absorbent liquid preferably provides an absorption solution containing at least one chemical compound selected from the group comprising monoethanolamine (MEA), diglycolamine (DGA), diethanolamine (DEA), methyldiethanolamine (MDEA), 2-amino-2-methyl-1-propanol (AMP), piperazine (PZ), ammonia, amines, alkanolamines, their derivatives and other chemical solvents and/or mixtures thereof. The absorbent liquid may further comprise at least one chemical component selected from the group comprising kinetic enhancers, corrosion inhibitors, anti-foam chemicals, oxygen scavengers, salts, neutralizers, anti-fouling chemicals and anti-degradation chemicals.

The absorbent liquid may comprise at least one chemical component selected for absorbing, assimilating, or otherwise reacting with a gas selected from the group comprising CO₂, H₂S, SO₂, and NO_{R}. In another embodiment, the absorbent liquid comprises a desiccating liquid containing at least one chemical compound selected from the group comprising monoethylene glycol (MEG), diethylene glycol (DEG), or triethylene glycol (TEG). The gaseous component selected for removal in this case is water vapor (H₂O).

While it will be apparent that the invention herein described is well calculated to achieve the benefits and advantages set forth above, it will be appreciated that the invention is susceptible to modification, variation and change without departing from the spirit thereof.

What is claimed is:

1. A gas processing facility for the separation of a fluid stream, the facility comprising:
a first co-current contactor configured to receive (i) an initial gas stream comprising a non-absorbing gas and an acid gas and (ii) a second liquid solvent, the first co-current contactor also being configured to release (iii) a first partially-sweetened gas stream and (iv) a first partially-loaded gas-treating solution; and
a final co-current contactor configured to receive (i) a previous partially-sweetened gas stream and (ii) a regenerated liquid solvent, and configured to release (iii) a final sweetened gas stream and (iv) a final lightly-loaded gas-treating solution, wherein the initial gas stream is at least one of:
a tail gas stream from a Claus sulfur recovery process,
an acid gas stream from a solvent regeneration process requiring H₂S enrichment,
a synthesis-gas stream,
an acid gas from a cement plant, and
a gas stream created internally within the gas processing facility.

2. The gas processing facility of claim 1, wherein the gas stream created internally within the gas processing facility is:
a flash gas stream from a flash drum, or
an impurities stream from a regenerator.

3. The gas processing facility of claim 1, wherein:
the acid gas received by the first co-current contactor comprises primarily carbon dioxide; and
the second liquid solvent and the regenerated liquid solvent are selected to preferentially remove carbon dioxide from a gas stream comprising hydrocarbons.

4. The gas processing facility of claim 1, wherein:
the acid gas received by the first co-current contactor comprises primarily hydrogen sulfide; and
the second liquid solvent and the regenerated liquid solvent are selected to preferentially remove hydrogen sulfide from a gas stream comprising hydrocarbons.

5. The gas processing facility of claim 1, further comprising:
a second co-current contactor configured to receive (i) the first partially-sweetened gas stream and (ii) a third liquid solvent, and is configured to release (iii) a second partially-sweetened gas stream and (iv) a second partially-loaded gas-treating solution; and
the regenerated liquid solvent is comprised at least in part of a regenerated solvent stream whereby an acid gas has been substantially removed from at least the first partially-loaded gas-treating solution.

6. The gas processing facility of claim 5, further comprising:
a flash drum for releasing hydrocarbon and H₂O vapors from the second partially-loaded gas-treating solution; and
a pump for increasing pressure of the second partially-loaded gas-treating solution before the second partially-loaded gas-treating solution enters the first co-current contactor.

7. The gas processing facility of claim 5, wherein:
the first co-current contactor, the second co-current contactor, the final co-current contactor, or combinations thereof, comprise a short-contact time mixing device having at least one of a centrifugal mixer, a static mixer, a mist eliminator, a venturi tube, an electrostatic precipitator, and an eductor.

8. The gas processing facility of claim 5, wherein:
the first co-current contactor and the second co-current contactor reside within a shell; and
the shell is refrigerated.

9. The gas processing facility of claim 5, wherein:
a jacket is placed around the first co-current contactor, the second co-current contactor, or both; and
a cooling medium is circulated within the jacket.

10. The gas processing facility of claim 5, further comprising:
a third co-current contactor configured to receive (i) the second partially-sweetened gas stream and (ii) a fourth liquid solvent, and configured to release (iii) a third partially-sweetened gas stream and (iv) a third partially-loaded gas-treating solution; and wherein:
the third liquid solvent received by the second co-current contactor comprises the third partially-loaded gas-treating solution released by the third co-current contactor; and
the second partially-loaded gas-treating solution is heavily loaded with acid gases.

11. The gas processing facility of claim 5, wherein the regenerated liquid solvent received by the final co-current contactor comprises the regenerated first partially-loaded gas-treating solution.

12. The gas processing facility of claim 11, wherein the regenerated liquid solvent received by the final co-current contactor further comprises the second partially-loaded gas-treating solution such that the first and second partially-loaded gas-treating solutions are together regenerated to form the regenerated liquid solvent received by the final co-current contactor.

13. The gas processing facility of claim 5, wherein the second liquid solvent received by the first contactor at least partially comprises a regenerated solvent stream.

14. The gas processing facility of claim 5, further comprising:
a cooler for cooling the second partially-loaded gas-treating solution.

15. The gas processing facility of claim 5, wherein:
an operating temperature of the first co-current contactor is different than the operating temperatures of the second co-current contactor, the final co-current contactor, or both.

16. The gas processing facility of claim 1, wherein:
an inlet pressure of the fluid stream into the first co-current contactor is about 15 to 100 psig.

17. The gas processing facility of claim 1, wherein:
the second liquid solvent and the regenerated liquid solvent comprise amine.

18. The gas processing facility of claim 17, wherein:
the amine comprises a secondary amine, a primary amine, a tertiary amine, or combinations thereof.

19. The gas processing facility of claim 1, wherein the second liquid solvent and the regenerated liquid solvent comprise physical solvents or solvents comprising a mixture of physical and chemical solvents.

20. A method of separating an initial gas stream in a gas processing facility, the gas stream comprising a non-absorbing gas and an acid gas, and the method comprising:
providing at least a first co-current contactor, a second co-current contactor and a final co-current contactor, each of these co-current contactors being configured (i) to receive a gas stream and a liquid solvent, and (ii) to release a sweetened gas stream and a separate loaded gas-treating solution;
arranging the first co-current contactor, the second co-current contactor and the final co-current contactor to deliver the respective sweetened gas streams as progressively sweetened gas streams in series;
further arranging the final co-current contactor, the second co-current contactor and the first co-current contactor to deliver the respective gas-treating solutions as progressively richer gas-treating solutions in series;
delivering a regenerated liquid solvent to the final co-current contactor; and
operating the gas processing facility in order to remove acid gas from the initial gas stream and deliver a final sweetened gas stream.

21. The method of claim 20, wherein the non-absorbing gas comprises a hydrocarbon gas or nitrogen.

22. The method of claim 21, wherein:
the first co-current contactor receives (i) the initial gas stream and a (ii) second liquid solvent, and releases (iii) a first partially-sweetened gas stream and (iv) a first partially-loaded gas-treating solution;
the second co-current contactor receives (i) the first partially-sweetened gas stream from the first co-current contactor and (ii) a third liquid solvent, and releases (iii) a second partially-sweetened gas stream and (iv) a second partially-loaded gas-treating solution, and
the final co-current contactor receives (i) a previous partially-sweetened gas stream and (ii) a regenerated liquid solvent, and releases (iii) a final sweetened gas stream and (iv) a final lightly-loaded gas-treating solution.

23. The method of claim 20, wherein the initial gas stream is at least one of:
a tail gas stream from a Claus sulfur recovery process,
an acid gas stream from a solvent regeneration process requiring H₂S enrichment,
an acid gas from a cement plant, and
a gas stream created internally within the gas processing facility.

24. The method of claim 23, wherein the gas stream created internally within the gas processing facility is:
a flash gas stream from a flash drum, or
an impurities stream from a regenerator.

25. The method of claim 21, wherein:
the acid gas comprises primarily carbon dioxide; and
the second liquid solvent and the regenerated liquid solvent are selected to remove carbon dioxide from a gas stream comprising hydrocarbons.

26. The method of claim 21, wherein:
the acid gas comprises primarily hydrogen sulfide; and
the second liquid solvent and the regenerated liquid solvent are selected to remove hydrogen sulfide from a gas stream comprising hydrocarbons.

27. The method of claim 21, wherein:
the initial gas stream is a flue gas stream;
the non-absorbing gas comprises nitrogen;
the acid gas comprises primarily carbon dioxide; and
the second liquid solvent and the regenerated liquid solvent are selected to preferentially remove carbon dioxide.

28. The method of claim 22, wherein:
the previous sweetened gas stream received by the final co-current contactor comprises the second partially-sweetened gas stream released from the second co-current contactor; and
the third liquid solvent received by the second co-current contactor comprises the final lightly-loaded gas-treating solution released by the final co-current contactor.

29. The method of claim 22, further comprising:
using a flash drum, releasing hydrocarbon and H₂O vapors from the second partially-loaded gas-treating solution; and thereafter
boosting the pressure of the second partially-loaded gas-treating solution before it enters the first co-current contactor.

30. The method of claim 22, wherein:
the first co-current contactor, the second co-current contactor, the final co-current contactor, or combinations thereof, comprise a centrifugal mixer, a static mixer, a mist eliminator, a venturi tube, an electrostatic precipitator, or combinations thereof.

31. The method of claim 20, wherein:
an inlet pressure of the initial gas stream into the first co-current contactor is about 15 to 1,000 psig.

32. The method of claim 20, wherein:
the second liquid solvent and the regenerated liquid solvent comprise amine.

33. The method of claim 32, wherein:
the amine comprises a secondary amine, a primary amine, a tertiary amine, or combinations thereof.

34. The method of claim 20, wherein:
the second liquid solvent and the regenerated liquid solvent comprise physical solvents or solvents comprising a mixture of physical solvents and chemical solvents.

35. The method of claim 22, further comprising:
operating the first co-current contactor at a temperature that is different than operating temperatures of the second co-current contactor, the final co-current contactor, or both.

36. The method of claim 20, further comprising:
operating the gas processing facility for a period of time;
analyzing composition of the initial gas stream; and
in response to changes in composition of the initial gas stream, modifying the gas processing facility.

37. The method of claim 36, wherein modifying the gas processing facility comprises at least one of (i) adding an additional co-current contactor, (ii) changing an operating temperature of at least one of the co-current contactors, or (iii) combinations thereof

38. The method of claim 20, wherein the liquid solvent received by the first contactor is comprised at least in part of a semi-lean solvent obtained from a separate gas sweetening process.

39. A process for removing a gaseous component from a gas stream, comprising:
(a) passing the gas stream through a first contactor and subsequently passing the gas stream through a second contactor;
(b) commingling and contacting the gas stream in the second contactor with a third absorbent liquid, wherein the third absorbent liquid and the gas stream flow co-currently in the second contactor, thereby producing a partially-loaded second absorbent liquid having a second concentration of the gaseous component and producing a gas stream depleted of the gaseous component;
(c) recovering the partially-loaded second absorbent liquid from the second contactor;
(d) passing a second absorbent liquid to the first contactor and commingling and contacting the gas stream in the first contactor with the second absorbent liquid,
wherein:
the second absorbent liquid and the gas stream flow co-currently through the first contactor, and
the first absorbent liquid comprises at least a portion of the partially-loaded second absorbent liquid, thereby producing a first absorbent liquid having a first concentration of gaseous component, the first concentration of the gaseous component in the first absorbent liquid being higher than the second concentration of the gaseous component in the second absorbent liquid; and
(e) recovering the first absorbent liquid from the first contactor.

40. The process of claim 39, wherein the partially-loaded second absorbent liquid recovered in step (c) is passed to the first contactor as the second absorbent liquid.

41. The process of claim 39, further comprising
(f) passing the first absorbent liquid to a regenerator system;
(g) producing in the regenerator system a partially-lean absorbent liquid and a lean absorbent liquid, the partially-lean absorbent liquid having a higher concentration of the gaseous component than a concentration of the gaseous component in the lean absorbent liquid;
(h) recycling the lean absorbent liquid to the final contactor in step (b); and
(i) passing the partially-lean absorbent liquid to the first contactor as the second absorbent liquid.

42. The process of claim 39, further comprising:
as part of step (a), passing the gas stream through a third contactor before the gas stream is passed through the first contactor, and, subsequent to step (c),
passing a fourth absorbent liquid to the third contactor and commingling and contacting the gas stream in the third contactor with the fourth absorbent liquid, wherein the fourth absorbent liquid and the gas stream flow co-currently through at least a portion of the third contactor, and wherein the third absorbent liquid comprises at least a portion of the partially loaded fourth absorbent liquid, thereby producing a third absorbent liquid having a third concentration of gaseous component, the third concentration of the gaseous component in the third absorbent liquid being higher than the fourth concentration of the gaseous component in the fourth absorbent liquid; and
subsequently removing the third absorbent liquid from the first contactor.

43. The process of claim 39, further comprising
regenerating the second absorbent liquid in a regenerator system, thereby producing a lean absorbent liquid, and
recycling the lean absorbent liquid as the third absorbent liquid.

44. The process of claim 39, wherein the absorbent liquid comprises a desiccating liquid containing at least one chemical compound selected from the group comprising monoethylene glycol (MEG), diethylene glycol (DEG), or triethylene glycol (TEG).

45. A process for removing a gaseous component from a gas stream, the process comprising:
(a) sequentially flowing the gas stream through a series of two or more contactors in a downstream direction; and
(b) passing an absorbent liquid through each of the two or more contactors co-currently with the flow of the gas stream in an opposite upstream direction, and recovering from each of the two or more contactors an absorbent liquid effluent stream comprising the gaseous component,
wherein:
the gas stream is progressively depleted of the gaseous component as the gas stream passes through each of the two or more contactors in the downstream direction,
the recovered absorbent liquid from each of the two or more contactors has a progressively higher concentration of the gaseous component in the upstream direction; and
at least a portion of the absorbent liquid recovered from one of the two or more contactors is used as the absorbent liquid for at least one contactor upstream of the flow of the gas stream.

46. The process of claim 45, wherein sequentially flowing the gas stream comprises:
passing the gas stream through a first contactor,
then through at least one additional contactor, and
then through a final contactor.

47. The process of claim 46, wherein passing an absorbent liquid comprises:
passing absorbent liquid recovered from the final contactor to a penultimate contactor,
passing absorbent liquid recovered from the penultimate contactor to an antepenultimate contactor, and
continuing recovery of the absorbent liquid from sequential contactors in the upstream direction, except that the absorbent liquid recovered from the first contactor is passed to a regeneration system, thereby producing a lean absorbent liquid, and
wherein the process further comprises recycling the lean absorbent liquid as the absorbent liquid for passing to the final contactor.
